(19) United States
(12) Patent Application Publication
(10) Pub. No.: US 2025/0154345 A1
(43) Pub. Date: May 15, 2025

(54) BIODEGRADABLE PLASTIC BAG COMPOSITION INCLUDING CELLULOSE RESIN AND METHOD OF MANUFACTURING PLASTIC BAG USING THE SAME

(71) Applicant: Green Package Solution Co., Ltd, Gumi-si (KR)

(72) Inventor: Sung Hun AHN, Yongin-si (KR)

(73) Assignee: Green Package Solution Co., Ltd, Gumi-si (KR)

(21) Appl. No.: 18/519,137

(22) Filed: Nov. 27, 2023

(30) Foreign Application Priority Data
Nov. 10, 2023 (KR) 10-2023-0153319

(51) Int. Cl. C08L 1/14

(52) U.S. Cl. CPC C08L 1/14; C08L 2201/06; C08L 2205/08

(57) ABSTRACT

The present disclosure relates to a biodegradable plastic bag composition and a method for manufacturing a plastic bag using the same, wherein the plastic bag composition includes: cellulose acetate propionate (CAP); and polybutylene succinate (PBS), wherein cellulose acetate propionate:polybutylene succinate, which is the weight ratio of the cellulose acetate propionate and the polybutylene succinate, is approximately 75:25 to approximately 90:10.

### CROSS-REFERENCE TO RELATED APPLICATION

This application claims priority to Korean Patent Application No. 10-2023-0155319 filed on Nov. 10, 2023 and all the benefits accruing therefrom under 35 U.S.C. § 119, the contents of which are incorporated by reference in their entirety.

### BACKGROUND

The present disclosure relates to a biodegradable plastic bag composition and a method for manufacturing a plastic bag using the same. An embodiment may provide a plastic bag with improved tensile strength, excellent elongation, and excellent biodegradability, so that the plastic bag may be used as a volume-rate garbage bag.

Plastic bags are mainly made of polyethylene (PE) or polypropylene (PP), and do not decompose for hundreds of years in a normal natural environment. In addition, when the plastic bags are incinerated, pollutants such as dioxin are generated.

In order to solve the problem, plastic bags made of biodegradable materials such as polylactic acid (PLA) or polyhydroxy alkanoic acid (PHA) have been developed and are being distributed. However, typical biodegradable plastic bags are low in tensile strength and elongation, and thus, are easily torn during use.

Meanwhile, efforts are being made to distribute biodegradable plastic bags even in the case of volume-based garbage bags which are used to separate and dispose of household waste, but the biodegradable plastic bags are not widely distributed due to the problem of easily tearing, thereby leaking the contents to the outside.

### PRIOR ART DOCUMENT

### [Patent Document]

(Patent Document 0001) Korean Patent Laid-open Publication No. 10-2459032

### SUMMARY

The present disclosure provides a biodegradable plastic bag composition capable of providing a plastic bag with improved tensile strength and elongation, and a method for manufacturing a plastic bag using the same.

In addition, the present disclosure is not easily torn, and thus, has excellent usability as a volume-rate garbage bag.

In addition, the present disclosure has a low defect rate during the manufacturing.

In accordance with an exemplary embodiment of the present disclosure, a plastic bag composition includes cellulose acetate propionate (CAP) and polybutylene succinate (PBS). An embodiment may further include a compatibilizer. A plastic bag manufactured using the plastic bag composition of the present disclosure may have a tensile strength of approximately 40 N/mm² to approximately 60 N/mm² and an elongation of approximately 70% to approximately 90%.

Cellulose acetate propionate:polybutylene succinate, which is the weight ratio of the cellulose acetate propionate and the polybutylene succinate, may be approximately 75:25 to approximately 90:10.

The content of the compatibilizer may be approximately 0.5 parts by weight to approximately 3 parts by weight of a compatibilizer based on 100 parts by weight, which is the sum of cellulose acetate propionate and the polybutylene succinate.

In accordance with another exemplary embodiment of the present disclosure, a method for manufacturing a plastic bag includes mixing cellulose acetate propionate (CAP) and polybutylene succinate (PBS) to prepare a mixture, and molding the mixture.

In the mixture, cellulose acetate propionate:polybutylene succinate, which is the weight ratio of the cellulose acetate propionate and the poly butylene succinate, is approximately 75:25 to approximately 90:10.

### BRIEF DESCRIPTION OF THE DRAWINGS

Exemplary embodiments can be understood in more detail from the following description taken in conjunction with the accompanying drawings, in which:

FIG. 1 is a flow chart of a method for manufacturing a plastic bag in accordance with an embodiment of the present disclosure.

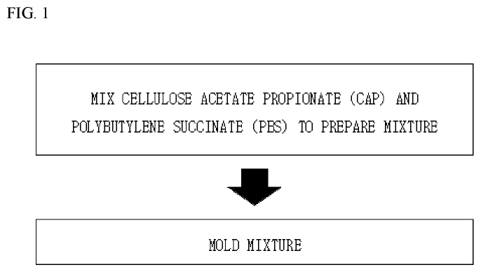

### DETAILED DESCRIPTION OF EMBODIMENTS

Hereinafter, preferred embodiments of the present disclosure will be described as follows with reference to the accompanying drawings. However, embodiments of the present disclosure may be modified into various other forms, and the scope of the present disclosure is not limited to the embodiments described below. In addition, the embodiments of the present disclosure are provided in order to more fully describe the present disclosure to those with average knowledge in the art.

A plastic bag composition according to an embodiment of the present disclosure includes cellulose acetate propionate (CAP) and polybutylene succinate (PBS).

The embodiment may further include a compatibilizer. A plastic bag manufactured using the plastic bag composition of the present disclosure may have a tensile strength of approximately 40 N/mm² to approximately 60 N/mm² and an elongation of approximately 70% to approximately 90%.

Cellulose acetate propionate (CAP) is a cellulose resin, and may be in a powder form. The cellulose acetate propionate may have an acetyl content of approximately 1 part by weight to approximately 1.5 parts by weight, preferably approximately 1.3 parts by weight, and may have a propionyl content of approximately 45 parts by weight to approximately 50 parts by weight, preferably approximately 48 parts by weight. In addition, the cellulose acetate propionate may have a 20° C. specific gravity of approximately 1 to approximately 1.3, preferably approximately 1.22, and may have a viscosity (viscosity in accordance with the ASTM D1343) of approximately 75 poise to approximately 80 poise, preferably approximately 76.5 poise.

The polybutylene succinate (PBS) is a polyester-based thermoplastic polymer resin, which is repeated using C₈H₁₂O₄ as a polymerization unit, and is represented by Structural Formula 1 below. The polybutylene succinate may impart flexibility, heat resistance, and biodegradability to a film or plastic bag manufactured by the present disclosure.

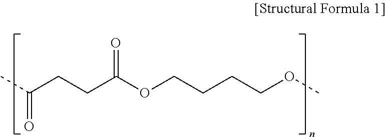

In the present disclosure, cellulose acetate propionate:polybutylene succinate, which is the weight ratio of cellulose acetate propionate and polybutylene succinate, is approximately 75:25 to 90:10, preferably 78:22 to approximately 80:20. If the content of the polybutylene succinate is too high, there is a problem in which the tensile strength decreases, and if the content is too low, the elongation decreases when manufactured into a film.

The compatibilizer allows cellulose acetate propionate and polybutylene succinate, which are heterogeneous materials, to react by being uniformly dispersed, so that the overall quality of a film or plastic bag manufactured by the present disclosure is uniform. The compatibilizer may preferably include a thermoplastic maleic anhydride graft copolymer.

The content of the compatibilizer may be approximately 0.5 parts by weight to approximately 3 parts by weight, preferably approximately 1 part by weight, based on 100 parts by weight, which is the sum of the cellulose acetate propionate and the polybutylene succinate. If the content of the compatibilizer is too high, processability is reduced, thereby making it difficult to uniformly control the thickness of the film and there is a problem of reducing the elongation. If the content is too low, the two materials may not be evenly dispersed, so that the manufactured film may have locally different physical properties.

The embodiment may further include an antioxidant. The antioxidant may perform the function of preventing the cellulose acetate propionate and the polybutylene succinate from being oxidized and decomposed, and improving the processability. The antioxidant may be a phenol-based antioxidant such as butylated hydroxy toluene (BHT), butylated hydroxide aniline (BHA), and terra-butyl hydroxide quinone (TBHQ), or an amine-based antioxidant such as a phenyl alpha-naphthalene diamine (PPD). Preferably, both a phenol-based antioxidant and an amine-based antioxidant may be used. As a result, a product which is excellent in tensile strength and elongation may be manufactured.

The content of the antioxidant may be approximately 0.1 parts by weight to approximately 0.3 parts by weight, preferably 0.2 part by weight of a compatibilizer, based on 100 parts by weight, which is the sum of the cellulose acetate propionate and the polybutylene succinate. When the content of the antioxidant is too high or too low, physical properties may deteriorate.

The method for manufacturing a plastic bag according to an embodiment of the present disclosure includes mixing cellulose acetate propionate (CAP) and polybutylene succinate (PBS) to prepare a mixture, and molding the mixture.

In the preparing of the mixture, the cellulose acetate propionate (CAP) and the polybutylene succinate (PBS) are the same as described above. In the present step, cellulose acetate propionate:polybutylene succinate, which is the weight ratio of the cellulose acetate propionate and the polybutylene succinate, is approximately 75:25 to approximately 90:10.

In the embodiment, a compatibilizer and/or an antioxidant may be further added in the present step. The compatibilizer and the antioxidant are the same as described above. The content of the compatibilizer added in the present step may be approximately 0.5 parts by weight to approximately 3 parts by weight, preferably approximately 1 part by weight, based on 100 parts by weight, which is the sum of the cellulose acetate propionate and the polybutylene succinate. In addition, the content of the antioxidant introduced in the present step may be approximately 0.1 parts by weight to approximately 0.3 parts by weight, preferably approximately 0.2 parts by weight, based on 100 parts by weight, which is the sum of the cellulose acetate propionate and the poly butylene succinate.

The present step may be performed at approximately 100° C. to approximately 250° C., preferably approximately 140° C. to approximately 190° C. A molten mixture may be prepared through the present step.

The molding step may be performed by various methods for manufacturing a film or an envelope by using a molten resin. The one embodiment may be performed by a blown film extrusion method. The present step may be performed at a temperature of approximately 140° C. to approximately 190° C. at a pressure of approximately 70 kgf/cm³ to approximately 90 kgf/cm³, preferably 76 kgf/cm³.

### Examples: Manufacturing of Cellulose Film

The cellulose acetate propionate used in the examples is CAP 482-20 of Eastman Chemical Company, the polybutylene succinate used therein is BG5000M from ANKOR Bioplastics, the compatibilizer used therein is HFS0100 from PolyGroup, and the poly-butylene adipate terephthalate (PBAT) used therein is A400 from Kingfa.

Example 1 (60:40): Approximately 6.0 kg of the cellulose acetate propionate, approximately 4.0 kg of the polybutylene succinate, and approximately 100 g of the compatibilizer were placed in a blown film extruder and mixed. The temperature was set to approximately 140° C. to approximately 190° C. and the process pressure was set to approximately 76 kgf/cm³ to extract a film.

Example 2 (70:30): The same was manufactured in the same manner as in Example 1, except that approximately 7.0 kg of the cellulose acetate propionate and approximately 3.0 kg of the polybutylene succinate were introduced.

Example 3 (73:27): The same was manufactured in the same manner as in Example 1, except that approximately 7.3 kg of the cellulose acetate propionate and approximately 2.7 kg of the polybutylene succinate were introduced.

Example 4 (75:25): The same was manufactured in the same manner as in Example 1, except that approximately 7.5 kg of the cellulose acetate propionate and approximately 2.5 kg of the polybutylene succinate were introduced.

Example 5 (78:22): The same was manufactured in the same manner as in Example 1, except that approximately 7.8 kg of the cellulose acetate propionate and approximately 2.2 kg of the polybutylene succinate were introduced.

Example 6 (80:20): The same was manufactured in the same manner as in Example 1, except that approximately 8.0 kg of the cellulose acetate propionate and approximately 2.0 kg of the polybutylene succinate were introduced.

Comparative Example 1 (60:40): The same was manufactured in the same manner as in Example 1, except that approximately 4.0 kg of the poly-butylene adipate terephthalate was introduced instead of the poly butylene succinate.

Comparative Example 2 (70:30): The same was manufactured in the same manner as in Example 2, except that approximately 3.0 kg of the poly-butylene adipate terephthalate was introduced instead of the poly butylene succinate.

Comparative Example 3 (80:20): The same was manufactured in the same manner as in Example 6, except that approximately 2.0 kg of the poly-butylene adipate terephthalate was introduced instead of the polybutylene succinate.

### Experimental Example 1: Measurement of Tensile Strength

The cellulose films manufactured in Examples and Comparative Examples were cut to a size of approximately 100×25.4 mm and used to measure the tensile strength using a tensile machine according to the ASTM D882-02 method.

### Experimental Example 2: Measurement of Elongation

The cellulose films manufactured in Examples and Comparative Examples were cut to a size of approximately 100×25.4 mm and used to measure the elongation using a tensile machine according to the ASTM D882-02 method.

The tensile strength and elongation of Examples and Comparative Examples are listed in Table 1 below.

TABLE 1

| | CAP:PBS/PBAT | Tensile strength | Elongation |
|---|---|---|---|
| Classification | weight ratio | (N/mm²) | (%) |
| Example 1 | 60:40 | 20.99 | 129 |
| Example 2 | 70:30 | 30.01 | 101 |
| Example 3 | 73:27 | 33.14 | 78 |
| Example 4 | 75:25 | 26.77 | 51 |
| Example 5 | 78:22 | 40.39 | 77 |
| Example 6 | 80:20 | 48.47 | 89 |
| Comparative | 60:40 | 28.02 | 80 |
| Example 1 | | | |
| Comparative | 70:30 | 35.27 | 85 |
| Example 2 | | | |
| Comparative | 80:20 | — | — |
| Example 3 | | | |

In Examples, a film was normally manufactured in all ranges, and Examples 5 and 6 were excellent in both tensile strength and elongation. In Comparative Examples, a surging phenomenon occurred during the process of manufacturing a film, and in Comparative Example 3, the tensile strength and elongation could not be measured because a film was not extracted.

A biodegradable plastic bag composition in accordance with an embodiment of the present disclosure and a method for manufacturing a plastic bag using the same may provide a plastic bag with improved tensile strength and elongation.

In addition, the present disclosure is not easily torn, and thus, has excellent usability as a volume-rate garbage bag.

In addition, the present disclosure has a low defect rate during the manufacturing.

The present disclosure is not limited by the above-described embodiments and the accompanying drawings, but is intended to be limited by the appended claims. Accordingly, various types of substitutions, modifications, and changes may be made by those skilled in the art within the scope not departing from the technical spirit of the present disclosure described in the claims, and these substitutions, modifications, and changes may also belong to the scope of the present disclosure.

What is claimed is:

1. A plastic bag composition comprising:
cellulose acetate propionate (CAP); and
polybutylene succinate (PBS),
wherein cellulose acetate propionate:polybutylene succinate, which is the weight ratio of the cellulose acetate propionate and the polybutylene succinate, is approximately 75:25 to approximately 90:10.

2. The plastic bag composition of claim 1, further comprising approximately 0.5 parts by weight to approximately 3 parts by weight of a compatibilizer based on 100 parts by weight, which is the sum of cellulose acetate propionate and the polybutylene succinate.

3. The plastic bag composition of claim 1, wherein a plastic bag manufactured using the plastic bag composition has a tensile strength of approximately 40 N/mm² to approximately 60 N/mm² and an elongation of approximately 70% to approximately 90%.

4. A method for manufacturing a plastic bag, the method comprising:
mixing cellulose acetate propionate (CAP) and polybutylene succinate (PBS) to prepare a mixture; and
molding the mixture,
wherein in the mixture, cellulose acetate propionate:polybutylene succinate, which is the weight ratio of the cellulose acetate propionate and the polybutylene succinate, is approximately 75:25 to approximately 90:10.
